(19) United States
(12) Patent Application Publication
(10) Pub. No.: US 2004/0062389 A1
(43) Pub. Date: Apr. 1, 2004

(54) Method and device for protecting documents or for verifying authenticity of a document using an encrypted information produced by said method, and documents protected by said encrypted information

(76) Inventors: Patricia Etienne, Le Pouliguen (FR); Roger Suanez, Le Pouliguen (FR)

Correspondence Address: BIRCH STEWART KOLASCH & BIRCH, PO BOX 747, FALLS CHURCH, VA, 22040-0747, US

(21) Appl. No.: 10/451,951

(22) PCT Filed: Dec. 26, 2001
(86) PCT No.: PCT/FR01/04200

(30) Foreign Application Priority Data
Dec. 28, 2000 (FR) 00/17185

(51) Int. Cl. H04K 1/00

(52) U.S. Cl. 380/28

(57) ABSTRACT

The invention concerns a method for producing an encrypted information from character strings and numeric values of specific size and representing items to be protected for identifying forgery of administrative documents or documents delivered by public authorities comprising the following steps which consist in: condensing said strings into several numbers of n figures smaller in size than the number representing the size of the strings to constitute a first set of m intermediate results of n figures; transforming said m intermediate results, with an algorithm randomly drawn among several, into a second result of n figures expressed in base 10 produced by a matrix converting characters of an alphanumeric base into digital characters of a decimal base stored by a computing system; converting said second result expressed in base 10 into another so-called encrypted result with the same number of n figures, expressed in a mathematical base randomly selected by the computing system among a specific selection of available conversion bases stored by the computing system, to obtain an encrypted identifier.

The present invention relates to a device and method for the protection of documents or for the verification of the authenticity of a document by using encrypted information generated by the method, and to documents protected by the said encrypted information. The invention may be used, for example, for any identity papers or statutory papers or any document that requires a certain authenticity, for example registered documents and papers of civil persons or natural persons, such as holiday visas, work permits, health insurance or social security cards, passports, registration books or papers, driving licences, hunting or fishing permits, or other certificates, forms or documents issued by national authorities.

There is known, for example from the patent application EP 1 003 324, a system that enables documents resistant to forgery to be produced. Such documents comprise images that incorporate secret data. The specification discloses a method associated with the incorporation of hidden information in the images. Such a system makes it possible, for example for passports, for machine-detectable multibinary information to be hidden in an image present on the document. It is the analysis of the image and the exploitation of those pieces of information that subsequently allows authentication of the document. That system does not, however, allow a simple machine to be constructed that is readily transportable and that does not require a means for analysing the image in order for the authenticity of a document to be certified.

The present invention aims to overcome that disadvantage by proposing, firstly, a method for generating encrypted information.

That aim is achieved by a method that generates encrypted information from strings of characters and of numeric values of determined length and representing entries to be protected, for the purpose of identifying falsifications of administrative documents or documents issued by public authorities, characterised in that the method comprises:

a step for condensing those strings to a plurality of numbers of n digits each of a length smaller than the number representing the length of the strings, in order to constitute a first set of m intermediate results of n digits;

a step for transforming those m intermediate results, by means of an algorithm randomly selected from a plurality thereof, into a second result of n digits expressed in base 10 generated by a matrix for converting characters of an alphanumeric base to numeric characters of a decimal base that is stored by a computing system;

a step for converting that second result expressed in base 10 to another so-called encrypted result with the same number n of digits expressed in a mathematical base randomly selected by the computing system from a determined selection of available conversion bases stored by the computing system, in order to obtain an encrypted identifier.

According to another feature, the strings of alphabetic characters and the numeric values contained in the protected entries form, after conversion to a decimal base, expressions of algebraic functions each constituting algorithms, one of which is randomly selected from a plurality thereof numbered from (0 to n−1, the number of the algorithm used for the transformation being fixed by the modulus (n) of the decimal value of the character (x) selected randomly or chronometrically within a period of time, between two limits.

According to another feature, the result of the transformation by the asymmetric mathematical function of that algorithm is then expressed in a base (y), which is also randomly selected between two other limits.

According to another feature, the result is always represented by a constant number n of characters, the positions of which are numbered and contain units expressed in that randomly selected base (y).

According to another feature, the character (x) that determines the base (y) used to determine the so-called encrypted result is inserted chronologically amongst the characters that represent that encrypted result in position (q) defined by the integral quotient of the value of (x) divided by (n), by shifting by one position to the left, the characters of the encrypted result having a significance that is equal to or higher than the determined position.

According to another feature, at the end of the encryption, the random key character (x) is inserted at a position that has been predetermined by the designers of the computing device or computed.

According to another feature, the strings of characters of determined length and representing entries to be protected for the purpose of identifying falsifications of administrative documents or documents issued by public authorities are composed of truncations of alphabetic entries formed from long fields of alphanumeric data entry in which there are taken into account only a significant and constant number of characters falling within a base 36 for conversion of those truncations to values between 0 and 35 inclusive, the memory registers concerned and not written to being set to zero.

According to another feature, the method generates encrypted information, starting from a first truncation of the name of a being and from a second truncation of a second piece of information identifying the living being, by steps which comprise:

a) converting in their entirety each of the letters of the two truncations to decimal numbers;

b) computing for each numeric value representing a character an intermediate result;

c) adding each of those intermediate results to obtain a first result called code name and representing encoded patronymic information;

d) determining a second result called Indent Spy as a function of a “random” algorithm randomly selected from a plurality thereof;

e) generating an encrypted identifier of the same length as the two truncations starting from the number representing the second result obtained in the preceding step, the second result being a plurality of numeric values representing characters, by performing a plurality of conversion algorithms on that result, and transforming at the output the numeric values so obtained and included between 0 and 61 to letters or numbers by using a conversion matrix defined by a base randomly selected for that computation, which allows the encrypted identifier to be obtained.

According to another feature, the method comprises inserting a character representing the base number used in the preceding computation and inserting a second character representing the position of insertion of the first character and the algorithm number used in step d.

According to another feature, the conversion of step a) is obtained by using a first determined base for converting characters to digits.

According to another feature, each intermediate result is composed of the numeric value that corresponds to the character of a character string constituting a truncation multiplied by the value of the base to a power corresponding to the value of the position of the character in the string.

According to another feature, each randomly selected “random” algorithm takes into account the code name, a date identifying a significant event of the living being and the algorithm number serving to generate that result.

According to another feature, the random algorithm of which the number is randomly selected for use in step d) is determined by:

the addition of the code-name information and the date minus the number representative of the factorial of 8 if the random selection defines the first algorithm;

the code name minus the date to which there is added the factorial of the number 8 minus the algorithm number if the random selection has defined the algorithm 1;

the code name plus the date less twice the factorial of the number obtained by subtracting from 8 the algorithm number if the algorithm is 2;

the ode name less the date plus twice the factorial of the number obtained by subtracting from 8 the algorithm number if the algorithm is three, that is to say twice factorial 5;

the code name plus the date less three times the factorial of the number obtained by subtracting from 8 the algorithm number, when the algorithm is the date, that is to say 3 times factorial 4; or

the code name less the date plus 3 times the factorial of the number obtained by subtracting from 8 the algorithm number when the algorithm is the number 5. that is to say the code name less the date plus 3 times factorial 3.

According to another feature, each of the algorithm intermediate results defined in step b) is obtained by multiplying the numeric value that represents the character belonging to one of the truncations by the numeric value representing the base raised to a power corresponding to the inverse order of the characters organised according to the first then the second truncation, then, where they exist, the other truncations.

Another aim is to propose a device for protecting documents or for verifying the authenticity of a document.

That aim is achieved by a device for protecting documents or for verifying the authenticity of a document that comprises means for entering and storing strings of characters and of numeric values of a determined length representing entries to be protected, for the purpose of identifying falsifications of administrative documents or documents issued by public authorities;

a means for condensing the string of characters by performing a first computational algorithm on a value obtained by conversion to a determined and fixed computational base nabling the device to generate a plurality of numeric values which are stored and represent stored strings in the form of a plurality of intermediate results;

means for transforming that plurality of results to a finite succession of digits by using an algorithm from a set of computational algorithms;

means for transforming the numeric result obtained by using a transformation base randomly selected from a plurality thereof, those transformation means thereby generating an encrypted identifier formed from digits and letters and stored, means for inserting into the encrypted identifier a first character, representing an identifier of the computational base, in a random position determined by a second character inserted in a fixed position in the encrypted identifier, in order to define, on the one hand, the position of the first character and, on the other hand, the number of the algorithm randomly selected from a plurality thereof.

According to another feature, the strings of characters and of numeric values are composed of at least one truncation of the name and of another piece of information that identifies a being, and the device comprises means for storing a date that represents an event associated with the being.

According to another feature, the device for protecting documents comprises means for selecting a second computational algorithm randomly selected from a plurality of algorithms, that second computational algorithm generating, from the numeric value obtained and from the date of the event, a second numeric result.

According to another feature, the device for protecting documents comprises a printer that allows, on the one hand, legible alphabetic information to be written on the document that enables identification of the natural or civil person, for example the surname, and a second piece of information such as, for example, the christian name, which identifies the being and, on the other hand, allows an authentication number to be written on the document that is composed of the encrypted identifier and the two characters inserted in the encrypted identifier.

According to another feature, the device for verifying authenticity comprises means for entering a truncation of the identification of the natural or civil person, for example the surname and the christian name identifying the being, means for entering the authentication number of the document and computing means enabling, by performing an algorithm p rformed on a second character located in a fixed position, the determination of, firstly, the position of the first character representing the identifier of a computational base and, secondly the algorithm number randomly selected and used in the conversion computation for converting the alphabetic information composed of the first and second truncations of the identifiers of the natural or civil person to an encrypted code that will be compared with the value of the encrypted code obtained from the authenticity number of the document.

Another aim of the invention is to propose a protected document

That aim is achieved by the fact that the protected document comprises, in addition to pieces of information identifying the person in possession of the document, information, computed starting from a determined truncation, on the identification of the natural or civil person, for example the surname, the christian name and the date of birth, in accordance with a computational algorithm defined in a random manner from among a plurality of algorithms, after conversion of the truncation to a first base; the computed information is then expressed in a randomly determined computational base to form an encrypted identifier, a character that represents the random computational base being inserted into the encrypted information in a random position defined by a character inserted into a determined p sition, that character of determined position representing in the first computational base a value of which the quotient by a prime number supplies the position of the identifying character of the random base of the coding, the remainder of the quotient supplying the algorithm number randomly selected from the plurality of algorithms.

Other features and advantages of the present invention will be illustrated more clearly by reading the description hereinbelow with reference to the accompanying drawings in which:

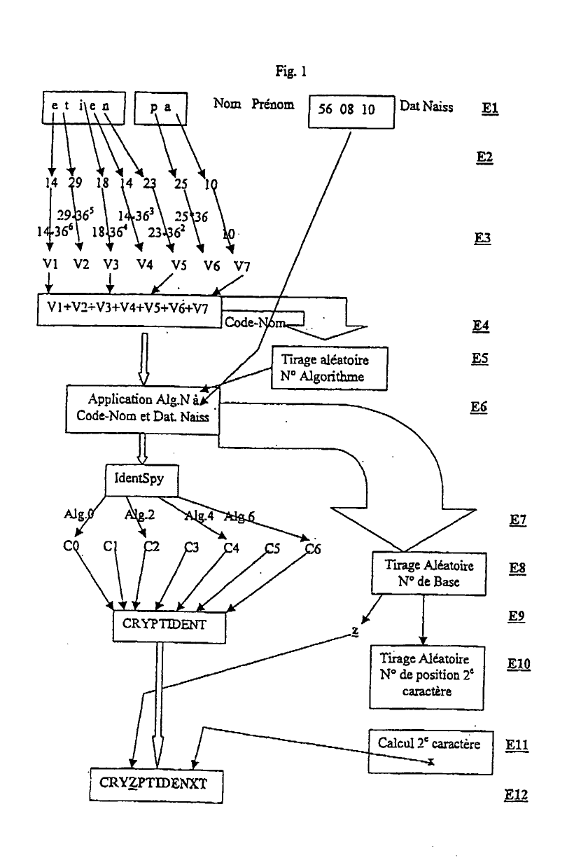

FIG. 1 is a diagrammatic view of the steps of a variant implementing the method of computing encrypted information that enables authentication of a document;

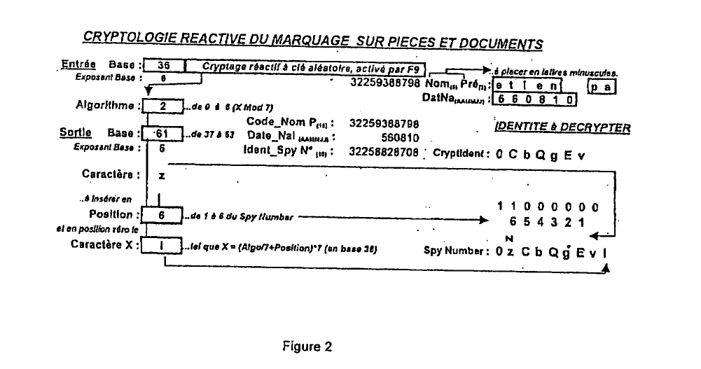

FIG. 2 shows the application of that computing method to a specific example in which the intermediate results are stored in the course of the computation in a device Implementing the invention;

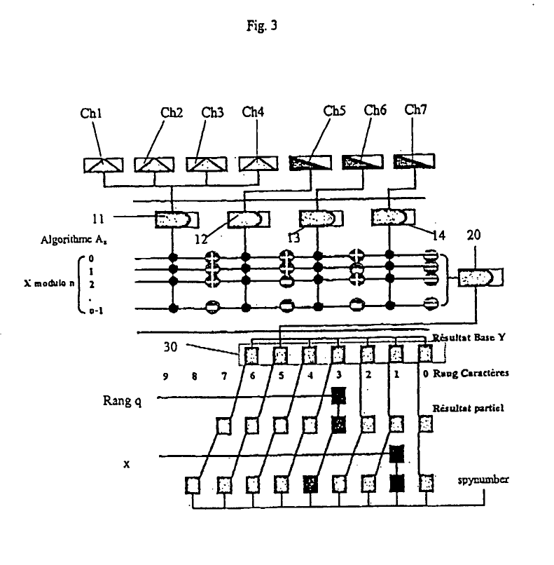

FIG. 3 is a diagrammatic view of the steps of a second implementation of the method of computing encrypted information that enables authentication of a document

The invention will now be described with reference to FIGS. 1 and 2.

The method implemented by the device comprises entering, into a first memory register of the device of the invention, alphabetic information representing a fixed truncation having 5 characters, the identifier of the natural or civil person for example, the name of the being for whom the document has been issued and whose document should be protected against fraud or of whom it is sought to verify the authenticity of the document presented.

In a second memory register containing two other characters, the user enters a second piece of alphabetic information representing a truncation of a second identifying word in letters, for example the christian name. A keyboard associated with the means known by the person skilled in the art enables such an operation. A display device associated with the computing device allows the user to verify the accuracy of the entered or computed information.

In a third register, 6 digits representing a significant and characteristic event of the being or the civil person for whom an authority seeks to verify the authenticity of a document or for whom the authority seeks to protect a document that it is going to return to that person. Such an event may be, for example, the date of birth, if the document in question is identity papers, or the date on which the document or the authorisation, for example, for a hunting or driving licence or import licence, was obtained. This step is represented by the step (E1) in FIG. 1. Each of the letters of the first and second truncations is converted in the course of a step (E2), by using a correspondance matrix, in a first fixed or determined base, for example of position 36 as defined in appendix 1, between the letters of the truncations and the numeric values defining that base. Thus, in a base of order 36 shown in appendix 1, the letter e represents the numeric value 14, the letter t the numeric value 29 and so on. Those representative numeric values in the fixed base of the characters of the truncation will then be transformed in the course of step (E3) into numeric values, the value of which will depend on the position of the numeric value representing the character in the truncations, by multiplying each of the numeric values by the order of the base, that is to say the value 36 raised to a power representing the position of the character or of the numeric value in the succession of the two truncations, those positions being determined in the inverse direction. Thus, the value 10 furthest to the right, which corresponds to the letter a, is allotted an exponent 0, while the value 14 furthest to the left, which corresponds to the letter e, is allotted the exponent 6 by the computing device, that is to say that 14 will be multiplied by the order of the base exponent 6, that is (36)⁶, to generate a first value V1=14 36⁶, a second value V2=29 36⁶ etc., as represented in step E3 of FIG. 1. Each of the values V1 to V7 so generated constitutes an intermediate result, which will be added to the other intermediate results in step (E4) to give a first result 32259388798 called “code name”. To that first result, the computing device will apply an algorithm randomly selected from a plurality of algorithms. In effect, it is the number N of the so-called “random” algorithm that is “random” since it is determined by a random selection. Step (E5) shows, for example referring to FIG. 2, that the random algorithm number 2 has been selected since the random selection has extracted the number 2. The application in step (E6) of the algorithm number 2 to the value representing the first result “code name” to which there is added the numeric truncation formed, for example, by the third truncation, enables generation of a second result which is identified in FIG. 2 by the name Indent Spy. From that second result 32258828708 so obtained by application of that algorithm, the computing device will generate, in step (E7), n alphanumeric values C0, C1 . . . Cn. The number n of numeric values obtained from the second result corresponds to the same number of characters of the first and second registers containing the stored truncations. Each of the n computational algorithms performed by the computing device is the next in sequence. The first algorithm effects the division of the second result by the value (61) of the position of the fixed base selected randomly at the output, for example from among the bases having orders 37 to 63, the whole raised to the power n−1(n representing the position by counting starting from the right of the computed numeric value Cᵢ). The device thus computes a first result of which it submits the decimal part to a register and retains the integral part as first numeric value C0. In the example of FIG. 2, 32258828708/61⁶=0.62613731, the character C0 is 0. Each of the following characters C1 to Cn is computed by taking the decimal value of the preceding character, in this case 0.62613731, and multiplying it by 61=38.194376 to derive from the integer the value C1=38. The numeric values C0 to C6 obtained are represented in appendix 3 by a Table of those values C0 to Cn. Each of the values C1 to Cn will be transformed in step E9 to an alphabetic character or digit, by using a conversion matrix according to a base of which the number (order) is randomly selected in step (E8) from a base of which the order is included between the values 37 and 63. Each of those values represented in the appendix 3 and converted to the base of order 61 will correspond to a letter or a digit. Thus the numeric value C1=38 corresponds to the character C in the base 61 and the numeric value 31 corresponds to the character v (see appendix 2). That transformation will thus allow, in Step E8, the generation of an encrypted identifier called a “cryptident” (FIG. 2). The device will, in step (E12), insert into that encrypted identifier a first character “Key 1” derived by a determined algorithm from the order of the base. In the example of FIG. 2, after having converted the number representing the order (61) of the base to a character z by a conversion algorithm represented in the column “Base Choice” at the output of the matrix of appendix 2, another random selection enables, in step E11, the position of insertion of that first output conversion base character “Key 1” to be determined, and a computational algorithm of a second character “Key 2” defining the position of the first character “Key 1” allows, by using the “random” algorithm number employed in step E5 and the numeric value representing the position randomly selected in step (E1), extraction of a numeric value transformed, in a computational fixed base of position 36 represented in appendix 1, to an alphabetic or numeric character Key 2 (I in the example FIG. 2. X in the example FIG. 1). That second character Key 2 is inserted in step (E2) into a fixed position determined by the device in order to define a piece of information which is called a “spynumber”,

Thus, the device for protecting documents will comprise those different algorithms, memory means and the definition of the fixed position of the position character as well as matrix tables for conversion of the various numeric values obtained in the course of computations for converting those numeric values to letters or digits. The input base of order (36), appendix 1, is defined by the first 9 digits to which there are added in succession the 26 letters of the alphabet in lower-case letters. The output base of which the order (61) is read in the column Output Base Selection, appendix 2, is defined starting from the base (36)=a and by adding, following the lower-case letters, the capital letters A and B for the bases 62 and 63. The extension of the characters included in the base of order (63) is defined by adding, following the capital letters, the hyphen character and the full stop character as shown in the Character Value column of appendix 2.

The device for authentication of a document allows, after the letters have been entered into the registers defining the truncation, an encrypted identifier to be recomputed, which identifier will be compared with the cryptident authentication numbers, derived from the “Spynumber”, represented in the example of FIG. 2 on the document. If the encrypted identifier value, computed using the encryption base of which the position (order) is determined by the position character and using an algorithm number defined by the position character, gives the same value as that appearing on the document, then the document is authentic. As soon as a piece of information among the pieces of information taken into account in the encryption computation has been changed, that is to say, either information belonging to the truncation concerning the surname or the christian name, or information concerning the date, then the result obtained will not agree with the Spy number, and that allows a falsification to be detected, as shown in FIG. 2. In the case of authentic documents, the encrypted identity will be able to serve to decrypt the information r presenting, for example, a photograph or prints of the individual stored in a file of a data base. The apparatus will thus be able to display or receive by downloading the photograph or print associated with the identity so certified.

FIG. 3 shows another variant of execution of the present invention which concerns a method for generating encrypted information from character strings (Ch1 to Ch4) or numeric value strings (Ch5 to Ch7) representing entries to be protected, for the purpose of identifying falsifications of administrative documents or documents issued by public authorities. Those strings (Ch1 to Ch7) are then condensed to a plurality (11 to 14) of intermediate results each comprising a number n of determined digits that is smaller than the number of characters and numeric values in the string. The intermediate results are then transformed, by an algorithm Aₓ randomly selected from a plurality (n) thereof, into a second result (20) of n digits expressed in base 10 generated by a matrix for conversion to a decimal base stored by the computing system. That second result (20) expressed in base 10 is then transformed into another so-called encrypted result (30) having the same number of digits, expressed in a mathematical base randomly selected by the computing system, in order to obtain an encrypted identifier. The base is randomly selected by a random selection algorithm of the computing system and from a certain number of available conversion bases stored by the computing system.

The alphabetic character strings and the numeric values contained in the protected entries form, after conversion to decimal base, the intermediate results (11 to 14) which constitute the expressions of the algebraic function of the algorithm Aₓ, randomly selected from a plurality (n) thereof, numbered from (0 to n−1, and fixed by the modulus (n) of the decimal value of a character (x) selected randomly or chronometrically within a period of time between two limits by the computing device. For example, the different algebraic functions may be formed by the different combinations of additions or subtractions between the intermediate results.

The result of the asymmetric mathematical function obtained by the algorithm applied to the intermediate results is then expressed in a base (y), which is also randomly selected between two other limits.

That result is always represented by a constant number (n) of characters, the positions of which are numbered and contain units expressed in that randomly selected base (y).

A random key character (x), which determines the base (y) used to determine the so-called encrypted result, is inserted chronologically among the characters representing that result, in position (q) defined by the integral quotient of the value of (x) divided by (n), by shifting by one position to the left, the characters of the result having a significance that is equal to or higher than the defined position.

When the encryption is complete, the random key character (x) is inserted into a position that has been predetermined by the designers of the computing device or c mputed.

The expression “Truncations of Alphabetic Entries” relates to long fields of alphanumeric data entry in which only a significant and constant number of characters falling within base 36 are taken into account, the memory registers concerned and not written to being set to zero.

According to the nature of the complete contents of certain alphabetic entries, their decimal conversion takes the value of the total number of characters of the strings and of the modulus 37 from the sum of the values of the ASCII codes of the characters present.

It will be obvious to persons skilled in the art that the present invention allows modes of execution in numerous others specific forms without leaving the sphere of application of the invention as claimed. Consequently, the present modes of execution should be considered as illustrations but can be modified within the sphere defined by the scope of the accompanying claims.

[image]

[image]

[image]

[image]

1. Method for generating encrypted information from strings of characters and of numeric values of determined lengths and representing entries to be protected, for the purpose of identifying falsifications of administrative documents or documents issued by public authorities, characterised in that it comprises:
a step for condensing those strings to a plurality of numbers of n digits each of a length smaller than the number representing the length of the strings, in order to constitute a first set of m intermediate results of n digits;
a step for transforming those m intermediate results, by means of an algorithm randomly selected from a plurality thereof, into a second result of n digits expressed in base 10 generated by a matrix for converting characters of an alphanumeric base to numeric characters of a decimal base that is stored by a computing system;
a step for converting that second result expressed in base 10 to another so-called encrypted result with the same number n of digits, expressed in a mathematical base randomly selected by the computing system from a determined selection of available conversion bases stored by the computing system, in order to obtain an encrypted identifier.

2. Method for generating encrypted information according to claim 1, characterised in that the strings of alphabetic characters and the numeric values contained in the protected entries form, after conversion to a decimal base, expressions of algebraic functions each constituting algorithms, one of which is randomly selected from a plurality thereof numbered from (0 to n−1, the number of the algorithm used for the transformation being fixed by the modulus (n) of the decimal value of the character (x) selected randomly or chronometrically within an period of time, between two limits.

3. Method for generating encrypted information according to claim 1 or claim 2, characterised in that the result of the transformation by the asymmetric mathematical function of that algorithm is then expressed in a base (y), which is also randomly selected between two other limits.

4. Method for generating encrypted information according to any one of claims 1 to 3, characterised in that the result is always represented by a constant number n of characters, the positions of which are numbered and contain units expressed in that randomly selected base (y).

5. Method for generating encrypted information according to any one claims 1 to 4, characterised in that the character (x) that determines the base (y) used to determine the so-called encrypted result is inserted chronologically amongst the characters that represent the encrypted result in position (q) defined by the integral quotient of the value of (x) divided by (n), by shifting by one position to the left, the characters of the encrypted result having a significance that is equal to or higher than the determined position.

6. Method for generating encrypted information according to claim 1, characterised in that at the end of the encryption, the random key character (x) is inserted at a position that has been predetermined by the designers of the computing device or computed.

7. Method for generating encrypted information according to claim 1, characterised in that the strings of characters of determined length and representing entries to be protected for the purpose of identifying falsifications of administrative documents or documents issued by public authorities are composed of truncations of alphabetic entries formed from long fields of alphanumeric data entry in which there are taken into account only a significant and constant number of characters falling within a base 36 for conversion of those truncations to values between 0 and 35 inclusive, the memory registers concerned and not written to being set to zero.

8. Method for generating encrypted information according to claim 1, characterised in that, starting from a first truncation of the name of a being and from a second truncation concerning a second piece of information identifying the living being, it comprises:
a) converting in their entirety (E2) each of the letters of the two truncations to decimal numbers;
b) computing (E3) for each numeric value representing a character an intermediate result;
c) adding (E4) each of those intermediate results to obtain a result called code name and representing encoded patronymic information;
d) determining (E7) a second result called Indent Spy as a function of a “random” algorithm randomly selected (E6) from a plurality thereof;
e) generating (E8) an encrypted identifier of the same length as the two truncations starting from the number representing the second result obtained in the preceding step, the second result being a plurality of numeric values representing characters, by performing a plurality of algorithms on that result, and transforming at the output the numeric values so obtained and included between 0 and 63 to letters or numbers by using a conversion matrix defined by a base randomly selected for that computation which allows the encrypted identifier to be obtained.

9. Method according to claim 8, characterised in that it comprises inserting (E11) a character representing the base number used in the preceding computation and inserting (E12) a second character representing the position of insertion of the first character and the algorithm number used in step d.

10. Method according to claim 8, characterised in that the conversion of step a) is obtained by using a first determined base for converting characters to digits.

11. Method according to claim 1 or 2 or 8, characterised in that each intermediate result is composed of the numeric value that corresponds to the character of a character string constituting a truncation multiplied by the value of the base to a power corresponding to the value of the position of the character in the string.

12. Method according to claim 8, characterised in that each “random” algorithm is randomly selected taking into account the code name, a date identifying a significant event of the living being and the algorithm number serving to generate that result.

13. Method according to claim 8, characterised in that the random algorithm of which the number is randomly selected for use in step d) is determined by;
the addition of the code-name information and the date minus the number representative of the factorial of 8, if the random selection defines the first algorithm;
the code name minus the date to which there is added the factorial of the number 8 minus the algorithm number, if the random selection has defined the algorithm 1;
the code name plus the date less twice the factorial of the number obtained by subtracting from 8 the algorithm number, if the algorithm is 2;
the code name less the date plus twice the factorial of the number obtained by subtracting from 8 the algorithm number, if the algorithm is three, that is to say twice factorial 5;
the code name plus the date less three times the factorial of the number obtained by subtracting from 8 the algorithm number, when the algorithm is the date, that is to say 3 times factorial 4; or
the code name less the date plus 3 times the factorial of the number obtained by subtracting from 8 the algorithm number, when the algorithm is the number 5, that is to say the code name less the date plus 3 times factorial 3.

14. Method according to claim 1 or claim 8, characterised in that each of the algorithm intermediate results defined in step b) of claim 8 or in claim 1 is obtained by multiplying the numeric value that represents the character belonging to one of the truncations by the numeric value that represents the base raised to a power corresponding to the inverse order of the characters organised according to the first then the second truncation, then, where they exist, the other truncations.

15. A device for protecting documents or for verifying the authenticity of a document that comprises means for entering and storing strings of characters and of numeric values of a determined length representing entries to be protected, for the purpose of identifying falsifications of administrative documents or documents issued by public authorities;
a means for condensing the string of characters by performing a first computational algorithm on a value obtained by conversion to a determined and fixed computational base enabling the device to generate a plurality of numeric values which are stored and represent stored strings in the form of a plurality of intermediate results;
means for transforming that plurality of results to a finite succession of digits by using an algorithm from a set of computational algorithms;
means for transforming the numeric result obtained by using a transformation base randomly selected from a plurality thereof, those transformation means thereby generating an encrypted identifier formed from digits and letters and stored, means for inserting into the encrypted identifier a first character, representing an identifier of the computational base, in a random position determined by a second character inserted in a fixed position in the encrypted identifier, in order to define, on the one hand, the position of the first character and, on the other hand, the number of the algorithm randomly selected from a plurality thereof.

16. A device for protecting documents or for verifying the authenticity of a document according to claim 15, characterised in that the strings of characters and of numeric values are composed of at least one truncation of the name and of another piece of information that identifies a being, and the device comprises means for storing a date that represents an event associated with the being.

17. A device for protecting documents or for verifying the authenticity of a document according to claim 16, characterised in that it comprises means for selecting a second computational algorithm randomly selected from a plurality of algorithms, that second computational algorithm generating, from the numeric value obtained and from the date of the event, a second numeric result.

18. A device for protecting documents according to claim 15 or claim 17, characterised in that it comprises a printer that allows, on the one hand, legible alphabetic information to be written on the document that enables identification of the natural or civil person, for example the surname, and a second piece of information such as, for example, the Christian name, which identifies the being and, on the other hand, allows an authentication number to be written on the document that is composed of the encrypted identifier and the two characters inserted in the encrypted identifier.

19. A device for protecting documents according to claim 15 or claim 17, characterised in that the device for verifying authenticity comprises means for entering a truncation of the identification of the natural or civil person, for example the surname and the Christian name identifying the being, means for entering the authentication number of the document and computing means enabling, by performing an algorithm on a second character located in a fixed position, the determination of, firstly, the position of a first character representing the identifier of a computational base and, secondly, the algorithm number used in the conversion computation for converting the alphabetic information composed of the first and second truncations of the identifiers of the natural or civil person to an encrypted code that will be compared with the value of the encrypted code obtained from the authenticity number of the document.

20. Protected document obtained by carrying out the method according to any one of claims 1 to 14, characterised in that it comprises, in addition to pieces of information identifying the person in possession of the document, information, computed starting from a determined truncation, on the identification of the natural or civil person, for example the surname, the Christian name and the date of birth, in accordance with a computational algorithm defined in a random manner from among a plurality of algorithms, after conversion of the truncation to a first base; the computed information is then expressed in a randomly determined computational base to form an encrypted identifier, a character that represents the random computational base being inserted into the encrypted information in a random position defined by a character inserted into a determined position, that character of determined position representing in a computational base a value of which the quotient by a prime number supplies the position of the identifying character of the random base of the coding, the remainder of the quotient supplying the algorithm number randomly selected from the plurality of algorithms.
